(19) United States
(12) Patent Application Publication
(10) Pub. No.: US 2009/0064144 A1
(43) Pub. Date: Mar. 5, 2009

(54) Community boundaries in a geo-spatial environment

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/897,689

(22) Filed: Aug. 30, 2007

(51) Int. Cl. G06F 9/46

(52) U.S. Cl. 718/100

(57) ABSTRACT

A method and system of community boundaries in a geo-spatial environment are disclosed. In one embodiment, a method of organizing a community network includes obtaining a location on a geo-spatial map, determining a representative in the community network associated with the location, obtaining a community boundary selection associated with a community from the representative, determining a region corresponding to the community boundary selection on the geo-spatial map, and creating a community boundary associated with the community on the geo-spatial map from the community boundary selection. The method may further include determining a residence of a member of the community network in the region, and associating the member with the community based on the residence. The method may also include obtaining a privacy preference corresponding to the community, and hiding a profile associated with the member from a public view of the community network based on the privacy preference.

### FIELD OF TECHNOLOGY

This disclosure relates generally to the technical fields of communications and, in one example embodiment, to a method and system of community boundaries in a geo-spatial environment.

### BACKGROUND

Neighborhoods may refer to geographically localized communities within larger cities, towns, and/or suburbs. In addition, multiple neighborhoods may be included in a single larger neighborhood and/or district. A neighborhood may be defined by a boundary that encloses an area corresponding to the neighborhood. The boundary may be well defined (e.g., in a gated community), or loosely defined (e.g., historic districts of a city). Residents of the neighborhood may be called neighbors.

The neighborhoods may be granted official or semi-official status through organizations such as neighborhood associations, neighborhood watches, and/or block watches. These organizations may regulate neighborhood appearances, offer services, and/or engage in other activities to promote and/or support communities created in the neighborhoods. For example, the organizations may specify lawn care, fence height, and/or other criteria related to maintenance of residences, provide services such as gatherings, neighborhood parks, security, promote economic development, education, and/or real estate development in the neighborhoods.

Neighborhood boundaries may often be decided by the residents of the neighborhoods rather than by external mechanisms such as redistricting. In other words, the neighborhoods may be associated with a common identity, which may be established using demographics shared by the residents and/or businesses in the neighborhood. Furthermore, neighborhood boundaries may change as neighborhood demographics and/or environments evolve over time. For example, new neighborhoods may be formed by an influx of residents from other areas. Additionally, economic development may cause neighborhoods to grow or shrink, as well as change the character of a particular neighborhood. As a result, neighborhood boundaries may be difficult to determine.

### SUMMARY

A method and system of community boundaries in a geo-spatial environment are disclosed. In one aspect, a method of organizing a community network includes obtaining a location (e.g., may include a latitude, a longitude and an altitude) on a geo-spatial map, determining a representative (e.g., may be an elected official) in the community network associated with the location, obtaining a community boundary selection (e.g., may be a polygon) associated with a community from the representative, determining a region corresponding to the community boundary selection on the geo-spatial map, and creating a community boundary associated with the community on the geo-spatial map from the community boundary selection.

The method may further include determining a residence of a member of the community network in the region, and associating the member with the community based on the residence. The method may also include obtaining a privacy preference corresponding to the community, and hiding a profile associated with the member from a public view of the community network based on the privacy preference. In addition, the method may include obtaining a vote corresponding to the community boundary selection, and creating the community boundary based on the vote.

In another aspect, a community network includes a member repository including a number of members, a geo-spatial repository including a number of locations (e.g., may include a latitude, a longitude and an altitude) on a geo-spatial map, a member management module configured to obtain member data (e.g., may include one of the number of locations) associated with each of the members, and a boundary management module configured to determine a representative (e.g., may be an elected official) from the members associated with the one of the locations, obtain a community boundary selection (e.g., may include a polygon.) associated with a community from the representative, determine a region corresponding to the community boundary selection on the geo-spatial map, and create a community boundary for the community on the geo-spatial map from the community boundary selection.

The member management module may further be configured to determine an activity level of each of the members in the member repository. The representative may be determined based on the activity level. The community network may include a representative interface accessible by the representative including a neighborhood management module configured to provide a neighborhood management option to the representative, a neighborhood cleanup module configured to provide a member profile regulation option to the representative, a neighborhood selection module configured to obtain the community boundary selection from the representative, and a forum configured to display a comment from one of the members.

The boundary management module may further be configured to determine a residence of the one of the members in the region, and associate the one of the members with the community based on the residence. The boundary management module may also be configured to obtain a privacy preference corresponding to the community, and hide a profile associated with the one of the members from a public view of the community network based on the privacy preference. In addition, the boundary management module may be configured to obtain a vote corresponding to the community boundary selection, and create the community boundary based on the vote.

In yet another aspect, a method of organizing a community network includes obtaining a number of proposed community boundaries corresponding to a community from at least one member of the community network, displaying each of the proposed community boundaries to a second member of the community network, sending a ballot including the proposed community boundaries to the second member, obtaining a vote corresponding to one of the proposed community boundaries from the second member, determining a validity (e.g., based on a residence of the second member) of the vote, applying the vote to the one of the number of proposed community boundaries based on the validity, and determining a community boundary corresponding to the community based on the vote.

The method may further include obtaining a privacy preference corresponding to the community from the second member, and hiding a plurality of profiles associated with the community from a public view of the community network based on the privacy preference. The method may also include determining a residence of the member in the community based on the community boundary, and associating the member with the community based on the residence.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a community network enabling community boundaries in a geo-spatial environment, according to one embodiment.

FIG. 2 is a user interface view displaying a community boundary selection corresponding to a community, according to one embodiment.

FIG. 3 is a user interface view of a voting module, according to one embodiment.

FIG. 4A is a user interface view enabling a member of the community to view profiles associated with the community, according to one embodiment.

FIG. 4B is a user interface view of restricting access to another member of the community network to view the profiles associated with the community, according to one embodiment.

FIG. 5 is a block diagram representation of a representative interface associated with a representative, according to one embodiment.

FIG. 6 is a flow chart to define a community boundary in the community network, according to one embodiment.

FIG. 7 is a flow chart to obtain a vote from a user corresponding to a community boundary and a privacy preference, according to one embodiment.

FIG. 8 is a diagrammatic system view of a data processing system in which any of the embodiments disclosed herein may be performed, according to one embodiment.

FIG. 9A is a process flow of creating the community boundary associated with the community of the geo-spatial map, according to one embodiment.

FIG. 9B is a continuation of the process flow of FIG. 9A, showing additional processes, according to one embodiment.

FIG. 10A is a process flow of determining the community boundary corresponding to the community based on a vote, according to one embodiment.

FIG. 10B is a continuation of the process flow of FIG. 10A, showing additional processes, according to one embodiment.

Other features of the present embodiments will be apparent from the accompanying drawings and from the detailed description that follows.

### DETAILED DESCRIPTION

A method and system of community boundaries in a geo-spatial environment are disclosed. In the following description, for the purposes of explanation, numerous specific details are set forth in order to provide a thorough understanding of the various embodiments. It will be evident, however to one skilled in the art that the various embodiments may be practiced without these specific details.

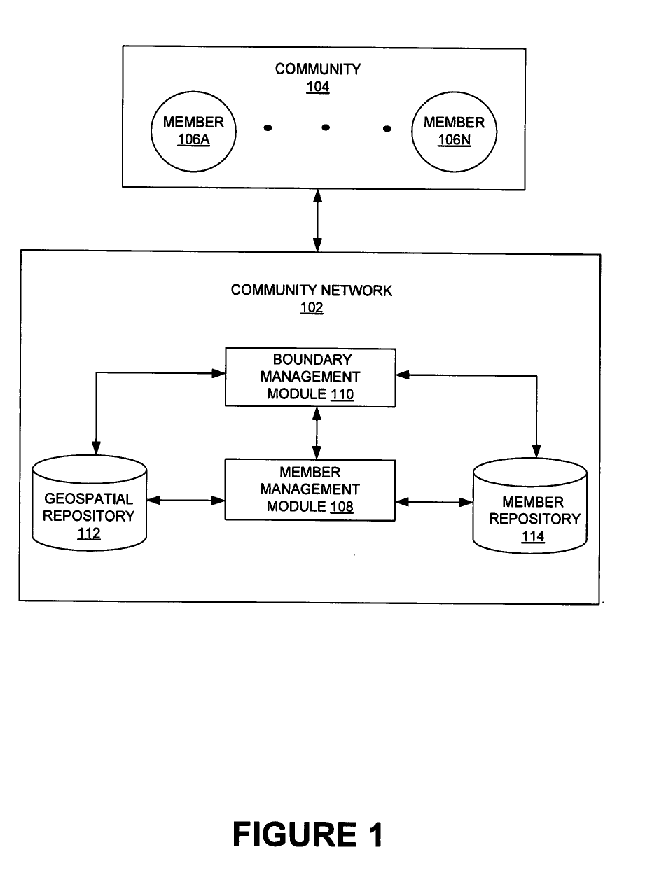

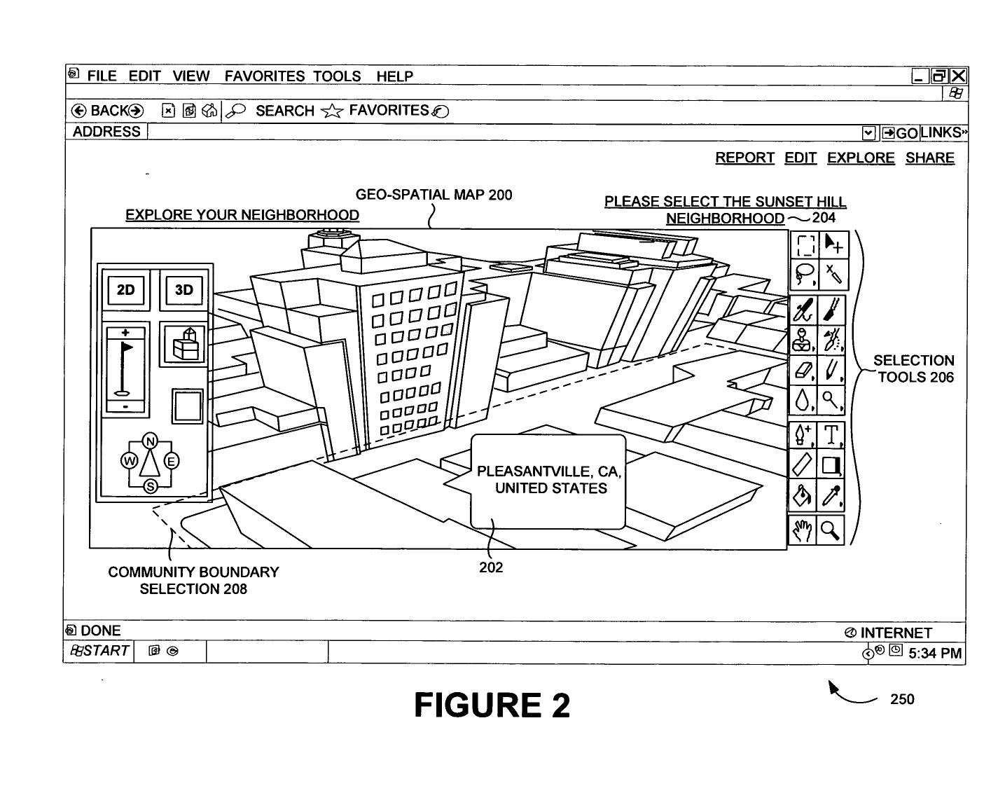

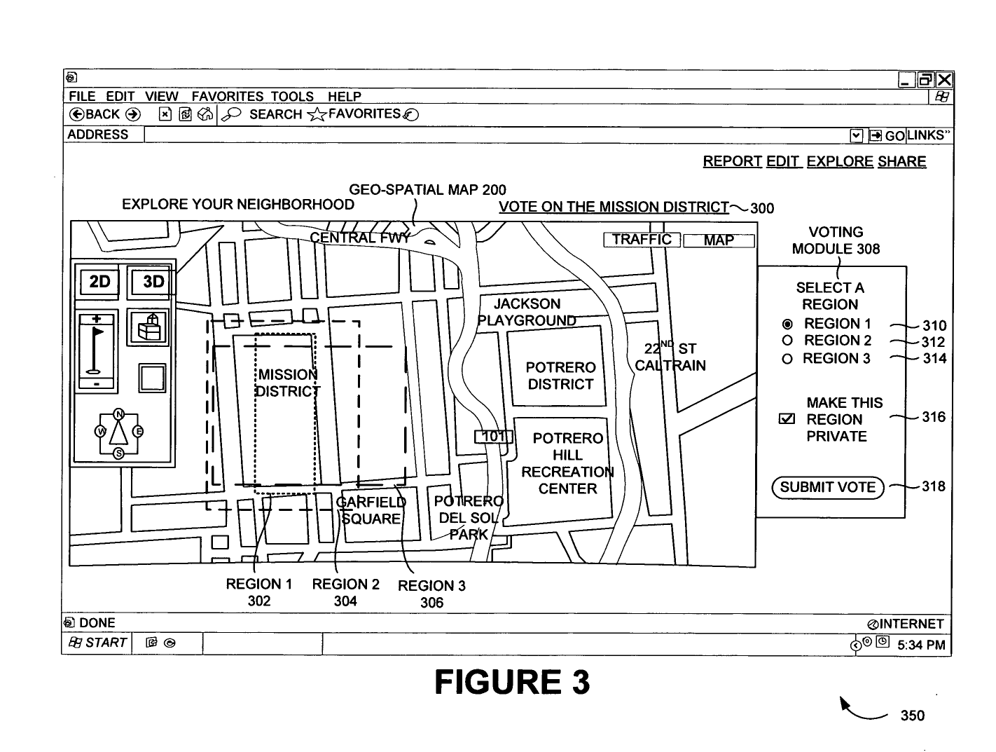

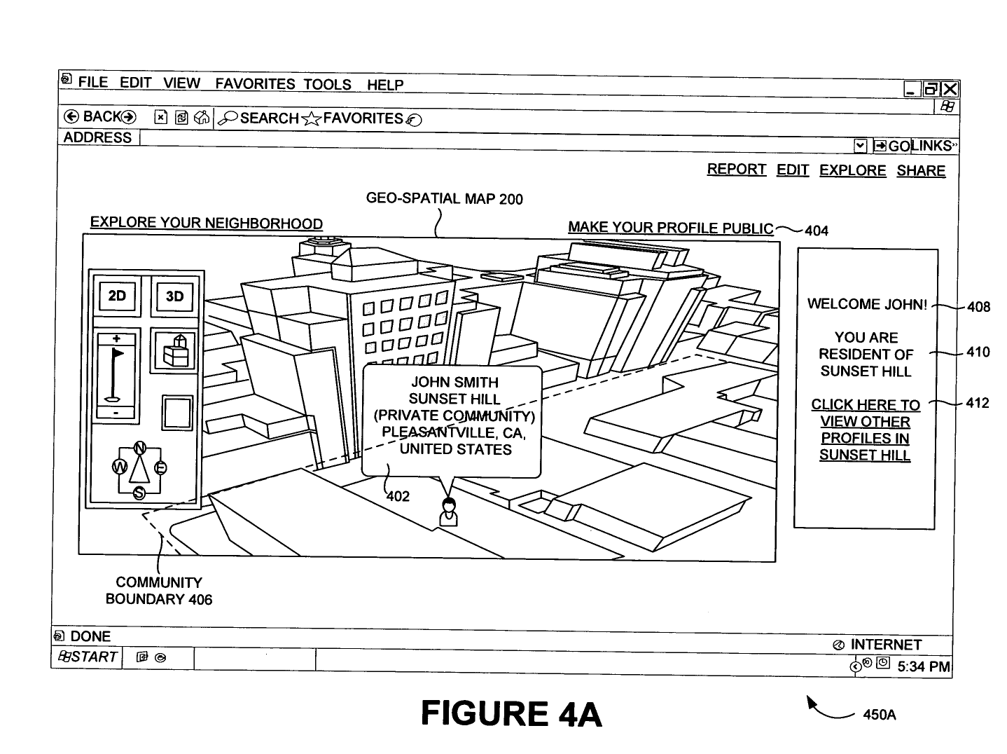

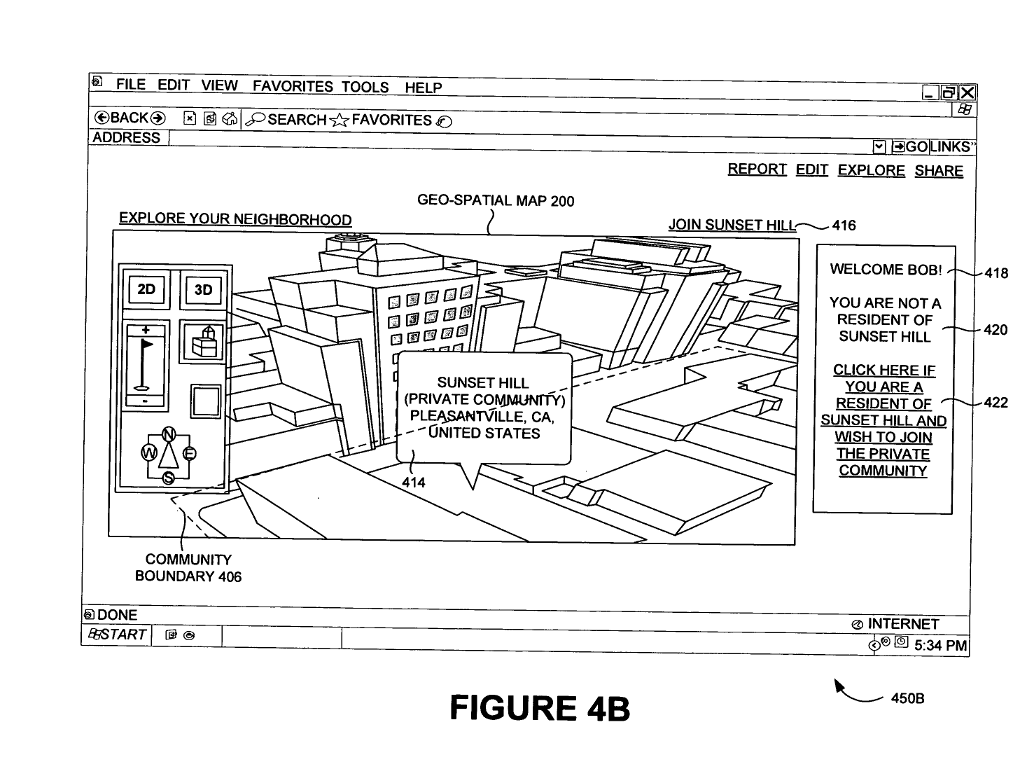

In one embodiment, a method of organizing a community network (e.g., the community network 102 of FIG. 1) includes obtaining a location (e.g., using the geo-spatial repository 112 of FIG. 1) on a geo-spatial map (e.g., the geo-spatial map 200 of FIG. 2), determining a representative (e.g., may include an elected official) in the community network 102 associated with the location, obtaining a community boundary selection (e.g., the community boundary selection 208 of FIG. 2) associated with a community (e.g., the community 104 of FIG. 1) from the representative, determining a region (e.g., of regions 1 302, 2 304 and 3 306 illustrated in FIG. 3) corresponding to the community boundary selection 208 (e.g., may include polygon) on the geo-spatial map 200, and creating (e.g., using the boundary management module 110 of FIG. 1) a community boundary (e.g., the community boundary 406 of FIG. 4) associated with the community 104 on the geo-spatial map 200 from the community boundary selection 208.

In another embodiment, a community network 102 includes a member repository (e.g., the member repository 114 of FIG. 1) including a number of members (e.g., the members 106A-N of FIG. 1), a geo-spatial repository (e.g., the geo-spatial repository 112 of FIG. 1) including a number of locations (e.g., may include a latitude, longitude and altitude coordinate) on a geo-spatial map 200, a member management module (e.g., the member management module 108 of FIG. 1) configured to obtain member data (e.g., may include one of the locations) associated with each of the members 106A-N, and a boundary management module (e.g., the boundary management module 110 of FIG. 1) configured to determine a representative (e.g., based on the activity level of each of the members 106A-N) associated with the location from the members 106A-N, obtain a community boundary selection 208 (e.g., may include a polygon) associated with a community 104 from the representative, determine a region corresponding to the community boundary selection 208 on the geo-spatial map 200, and create a community boundary 406 for the community 104 on the geo-spatial map 200 from the community boundary selection 208.

In yet another embodiment, a method of organizing a community network 102 includes obtaining a number of proposed community boundaries (e.g., the regions 1 302, 2 304 and 3 306 of FIG. 3) corresponding to a community 104 from a member (e.g., of the members 106A-N of FIG. 1) of the community network 102, displaying each of the proposed community boundaries 1 302, 2 304 and 3 306 to a second member (e.g., of the members 106A-N of FIG. 1) of the community network 102, sending a ballot including the proposed community boundaries 1 302, 2 304 and 3 306 to the second member 106, obtaining a vote (e.g., using the voting module 308 of FIG. 3) corresponding to one of the proposed community boundaries 1 302, 2 304 and 3 306 from the second member 106, determining a validity (e.g., based on a residence of the second member) of the vote, applying the vote to the one of the proposed community boundaries 1 302, 2 304 and 3 306 based on the validity, and determining a community bou boundary management module 110 of FIG. 1) corresponding to the community 104 based on the vote.

FIG. 1 is a system view of a community network 102 enabling community boundaries in a geo-spatial environment, according to one embodiment. Particularly, FIG. 1 illustrates the community network 102, a community 104, members 106A-N, a member management module 108, a boundary management module 110, a geo-spatial repository 112 and a member repository 114, according to one embodiment.

The community network 102 may be a network formed by association of members 106A-N having profiles associated with physical locations (e.g., residences, businesses, civic structures, etc.) in the community 104. The profiles may include information such as a name, address, contact information (e.g., phone number, email id, etc.), activity level, personal information (e.g., profession, hobbies, interests, etc.) and/or biographical information associated with the members 106A-N. In addition, the community network 102 may enable the members 106A-N to create and/or edit profiles containing information such as a name, address, contact information, picture and/or groups, etc. associated with other members 106A-N of the community 104.

The community 104 may refer to a group of members 106A-N residing in a region and connected with each other through the community network 102. The region may correspond to a geographic or geo-spatial region. For example, the region may correspond to a street, city, county, state, country, etc. The members 106A-N may include persons, businesses, and/or organizations associated with physical locations in the community 104.

The member management module 108 may obtain member data associated with the members 106A-N of the community network 102. For example, the member data may include profile information (e.g., name, age, profession, etc.), contact information (e.g., phone number, address, emailed, etc.) and/or a name of a community (e.g., the community 104 of FIG. 1) associated with each of the members 106A-N. A location of each of the members 106A-N may also be determined using the contact information provided. The member data may further be displayed in the profiles of the members 106A-N at the locations on a geo-spatial map (e.g., the geo-spatial map 200 of FIG. 4A-B).

The boundary management module 110 may create a community boundary (e.g., the community boundary 406 of FIG. 4A-B) for the community 104 on the geo-spatial map 200 from a community boundary selection (e.g., the community boundary selection 208 of FIG. 2). The community boundary selection 208 may be a polygon drawn by a representative of the community network 102. The polygon may be specified by clicking on points in the geo-spatial map 200. In one example embodiment, circles, squares, triangles, rectangles, etc. may be drawn using selection tools (e.g., using the selection tools 206 of FIG. 2) for providing the community boundary selection 208.

In one example embodiment, the representative may be a member 106 selected from the members 106A-N of the community network 102 based on an activity level of each of the members 106A-N. In the example embodiment, the activity level may be determined (e.g., using the member management module 108 of FIG. 1) based on a number of contributions (e.g., comments, reviews, profile edits, file-uploads, event-postings, etc.) performed by each member 106 of the community network 102 over a certain period of time. In other words, the activity level may be determined based on a list of activities and/or contributions to the community network 102 that the members 106A-N perform and/or make over a period of time. For example, the activities may include building up the community network 102, creating and/or deleting profiles, leaving comments, organizing events, performing social services, etc. The representative may also be an elected official, elected by the members 106A-N of the community 104.

For example, the community 104 may vote for the representative by nominating one or more members 106A-N for the representative's position. The nominated members 106A-N may only be eligible to run for the position if they are associated with an activity level above a certain threshold. The activity level of the members 106A-N may be determined by tallying a number of activity points for each member 106A-N. In addition, the threshold may be set at an arbitrary number of activity points. On the other hand, a certain number of members 106A-N with the highest number of activity points in the community 104 may be eligible to run for the representative's position. The representative may then be chosen using a popular vote of the members 106A-N of the community 104.

In an example embodiment, the boundary management module 110 may include functionality to determine a region corresponding to the community boundary selection 208 on the geo-spatial map 200. This may be facilitated by the representative of the community 104, who may specify the community boundary selection 208 as associated with a particular region on the geo-spatial map 200. The boundary management module 110 may also determine physical locations (e.g., residences) of the members 106A-N (e.g., using the geo-spatial repository 112 of FIG. 1) associated with the region. The members 106A-N of the community network 102 having residences in the region may be enabled to join the community 104 associated with the community boundary 406. In one example embodiment, a member 106 may be allowed to join the community 104 (e.g., associated with the community boundary selection 208) based on a confirmation of a residence of the member 106 at a location in the region.

For example, if the member 106 is not located in the region corresponding to the community boundary 406, then other community boundaries associated with the member's residence may be displayed to the member 106 on the geo-spatial map 200. Further, the member 106 may select one of the community boundaries displayed on the geo-spatial map 200 to join the community 104.

In addition, the boundary management module 110 may enable selection of a privacy preference corresponding to the community 104. In one embodiment, the privacy preference may include hiding profiles of the members 106A-N of the community 104 from a public view of the community network 102. In one example embodiment, the privacy preference corresponding to the community 104 may be selected by the members 106A-N of the community 104 through voting. In another example embodiment, the privacy preference corresponding to the community 104 may also be selected by the representative (e.g., the elected official) of the community 104. Additionally, profiles of the members 106A-N of the community 104 may be displayed to other members of the community network 102 based on the privacy preference selected by the members 106A-N and/or the representative of the community 104.

The geo-spatial repository 112 may be a database containing location information associated with the members 106A-N of the community network 102 on the geo-spatial map 200. In one example embodiment, the location information may be used to locate a residence of the member 106 within a community boundary 406 on the geo-spatial map 200. The member repository 114 may be a database containing the member data associated with the members 106A-N. In one example embodiment, locations associated with the members 106A-N may be obtained based on the member data stored in the member repository 114. The member data may be cross-referenced with the locations in the geo-spatial repository 112 to determine the membership of one or more members 106A-N in the community 104.

In the example embodiment illustrated in FIG. 1, the members 106A-N of the community 104 may select the privacy preference (e.g., through the voting module 308 of FIG. 3) to hide the community 104 from a public view through the community network 102. In other words, the members 106A-N of the community 104 may choose to prevent other members of the community network 102 from viewing profiles associated with the community 104. The community network 102 includes the member management module 108, the boundary management module 110, the geo-spatial repository 112, and the member repository 114 interacting with each other.

In one embodiment, a location (e.g., may include a latitude, a longitude and an altitude) may be obtained (e.g., using the geo-spatial repository 112 of FIG. 1) on the geo-spatial map 200. A representative (e.g., may be an elected official) in the community network 102 associated with the location may be determined (e.g., using the member management module 108 and the member repository 114 of FIG. 1). A community boundary selection (e.g., the community boundary selection 208 of FIG. 2) associated with a community (e.g., the community 104 of FIG. 1) may be obtained (e.g., using the boundary management module 110 of FIG. 1) from the representative.

In addition, a region corresponding to the community boundary selection 208 (e.g., may include a polygon) may be determined on the geo-spatial map 200. A community boundary (e.g., the community boundary 406 of FIG. 4A-B) associated with the community 104 may be created (e.g., using the boundary management module 110 of FIG. 1) on the geo-spatial map 200 from the community boundary selection 208.

A residence of a member (e.g., of the members 106A-N of FIG. 1) of the community network 102 may be determined in the region. The determination of the residence may be done by cross referencing member data in the member repository 104 with geo-spatial data in the geo-spatial repository 112. Further, the member 106 may be associated (e.g., using the boundary management module 110 of FIG. 1) with the community 104 based on the residence. In addition, a privacy preference corresponding to the community 104 may be obtained (e.g., through the voting module 308 of FIG. 3). A profile associated with the member 106 may be hidden from a public view of the community network 102 based on the privacy preference. A vote corresponding to the community boundary selection may be obtained (e.g., using the voting module 308 of FIG. 3). In addition, the community boundary 406 may be created (e.g., using the boundary management module 110 of FIG. 1) based on the vote.

In one embodiment, the member repository 114 may include any number of members 106A-N and the geo-spatial repository 112 may include a number of locations on the geo-spatial map 200. The member management module 108 may be configured to obtain the member data associated with each of the members 106A-N. The member management module 108 may further be configured to determine an activity level of each of the members 106A-N in the member repository 114.

The boundary management module 110 may be configured to determine the representative associated with the location from the members 106A-N, obtain the community boundary selection 208 associated with the community 104 from the representative, determine the region corresponding to the community boundary selection 208 on the geo-spatial map 200, and create the community boundary 406 for the community 104 on the geo-spatial map 200 from the community boundary selection 208.

The boundary management module 110 may further be configured to determine the residence of the member 106 in the region, associate the member 106 with the community 104 based on the residence, obtain the privacy preference corresponding to the community 104, and hide the profile associated with the member 106 from a public view of the community network 102 based on the privacy preference (e.g., specified by the member). In addition, the boundary management module 110 may be configured to obtain the vote corresponding to the community boundary selection 208, and create the community boundary 406 based on the vote.

FIG. 2 is a user interface view 250 displaying a community boundary selection 208 corresponding to a community (e.g., the community 104 of FIG. 1), according to one embodiment. Particularly, FIG. 2 illustrates a geo-spatial map 200, an address block 202, a select option 204, selection tools 206 and a community boundary selection 208, according to one embodiment.

The geo-spatial map 200 may graphically visualize the community boundary selection 208 drawn by a representative associated with the community 104 corresponding to a region (e.g., as illustrated in the address block 202 of FIG. 2). For example, the community boundary selection 208 may be drawn on the geo-spatial map 200 corresponding to the community 104 (e.g., associated with the address illustrated in address block 202). The address block 202 may display an address data (e.g., city, state, country, etc.) associated with the region corresponding to the community boundary selection 208.

The select option 204 may prompt selection of a particular neighborhood associated with the community boundary selection 208. In one embodiment, the member 106 may manually provide the community boundary selection 208.

The selection tools 206 may enable the representative to draw the community boundary selection 208 corresponding to the community 104 on the geo-spatial map 200. For example, the community boundary selection 208 may be a polygon drawn around a target region using the selection tools 206. The selection tools 206 may include, but are not limited to, a rectangle tool, a lasso tool, a polygon tool, a line tool, an elliptical tool, and/or other tools for selecting the region. In addition, the community 104 may be created by making use of the entries obtained from the target region corresponding to the community boundary selection 208.

In the example embodiment illustrated in FIG. 2, the user interface view 250 displays the community boundary selection 208 and the address block 202 on the geo-spatial map 200. The address block 202 displays an address “Pleasantville, Calif., United States” associated with the community boundary selection 208. In one example embodiment, “Sunset Hill Neighborhood” may be the community 104 corresponding to the community boundary selection 208 and associated with the address “Pleasantville, Calif., United States”. In other words, the “Sunset Hill Neighborhood” may correspond to a subset of Pleasantville, Calif., United States.

The select option 204 may request the member 106 of the community network 102 to provide the community boundary selection 208 associated with the Sunset Hill Neighborhood community. The user interface view 250 also displays a toolbar through which, the members 106A-N may adjust settings on the geo-spatial map 200. For example, the 2D option may allow the members 106A-N to visualize the two dimensional view of the residence in the geo-spatial map 200. The 3D option may enable the members 106A-N of the community 104 to generate the three dimensional view of residence in the geo-spatial map 200. The zoom control may facilitate the members 106A-N to zoom in or zoom out view of the residence in the geo-spatial map 200 to a desired scale.

FIG. 3 is a user interface view 350 of a voting module 308, according to one embodiment. Particularly, FIG. 3 illustrates the geo-spatial map 200, a vote option 300, region(s) 1 302, 2 304 and 3 306, the voting module 308, a select option 310, a check box 312 and a submit vote option 314, according to one embodiment.

The vote option 300 may enable a member 106 to select a region associated with his/her residence. For example, the member 106 may specify a community boundary (e.g., the community boundary 406 of FIG. 4A-B) corresponding to his/her residence. In addition, the member 106 may also vote for a privacy preference corresponding to the community 104. The privacy preference may include hiding profiles of the members 106A-N associated with the community 104 from a public view of the community network 102. In other words, the members 106A-N of the community 104 may view the profiles (e.g., may include address, email address, phone number, etc) associated the community 104 whereas members 106A-N of other communities may be restricted from accessing the profiles associated with the community 104.

The region(s) 1 302, 2 304, and 3 306 may be community boundaries created by representatives corresponding to community boundary selections (e.g., the community boundary selection 208 of FIG. 2). The voting module 308 may enable the members 106A-N of the community network 102 to vote for a particular region corresponding to their residences and to select the privacy preference corresponding to the regions 1 302, 2 304 and 3 306. The select option 310 may enable the members 106A-N of the community network 102 to select a region corresponding to their residence. For example, if the determined community boundary 406 corresponding to a residence is associated with region 1 302, then the member 106 may select region 1 through the select option 310.

The check box 312 may enable the members 106A-N of the community to select privacy preferences to render the region private by checking the check box 312. The submit vote option 314 may enable submission of votes by the members 106A-N of the community network 102. For example, the member 106 may submit a vote upon selection of the region and/or the privacy option as illustrated in FIG. 3.

In the example embodiment illustrated in FIG. 3, the user interface view 350 displays the regions 1 302, 2 304, and 3 306 and a voting module 308. The regions 1 302. 2 304, and 3 306 displayed (e.g., through the geo-spatial map 200 of FIG. 3) to the member 106 of the community network 102 corresponding to the residence “Mission District” are overlapping with each other (e.g., as illustrated in FIG. 3). The member 106 may select one of the regions 1 302, 2 304, and 3 306 for the residence “Mission District” based on the residence of the member 106 in the corresponding region. The member 106 may select a particular region associated with “Mission District” through the voting module 308. In one example embodiment, the representative of the community 104 may confirm the vote based on a validity of the vote. The validity may be determined based on the confirmation of the residence of the member 106 at the specified region.

As illustrated in FIG. 3, the member 106 selects the region 1 302 (e.g., using the select option 310 of FIG. 3) corresponding to the community boundary 406 associated with the Mission District. Further, the member 106 also makes the region 1 302 associated with the Mission District private by checking the check box 312. In one example embodiment, access to profiles associated with the region 1 302 may be restricted to the members 106A-N of the other regions (e.g., the region 2 304 and the region 3 306) based on the privacy preference specified by the members 106A-N of the region 1 302. Only members 106A-N associated with region 1 302 may view the profile associated with Mission District.

In one embodiment, a number of proposed community boundaries (e.g., the regions 1 302, 2 304 and 3 306) corresponding to a community 104 may be obtained from a member 106 of the community network 102. Further, the proposed community boundaries 1 302, 2 304 and 3 306 may be displayed to a second member 106 of the community network 102. A ballot including the proposed community boundaries 1 302, 2 304 and 3 306 may be sent to the second member 106 and a vote corresponding to one of the proposed community boundaries 1 302, 2 304 and 3 306 may be obtained from the second member 106.

A validity of the vote may be determined (e.g., based on a residence of the second member 106) and the vote may be applied to the one of the proposed community boundaries 1 302, 2 304 and 3 306 based on the validity. In addition, a community boundary (e.g., the community boundary 406 of FIG. 4) corresponding to the community 104 may be determined (e.g., using the boundary management module 110 of FIG. 1) based on the vote. For example, a residence of the member 106 in the community 104 may be determined (e.g., using the geo-spatial repository 112 of FIG. 1) based on the community boundary 406 and the member 106 may be associated with the community 104 based on the residence. A privacy preference corresponding to the community 104 may be obtained (e.g., using the voting module 308 of FIG. 3) from the second member and profiles associated with the community 104 may be hidden from a public view of the community network 102 based on the privacy preference.

FIG. 4A is a user interface view 400A enabling a member 106 of the community 104 to view profiles associated with the community 104, according to one embodiment. Particularly, FIG. 4A illustrates a block 402, a make your profile public option 404, a community boundary 406, a welcome message 408, a message block 410 and click option 412, according to one embodiment.

The block 402 may display member data associated with the member 106 of the community 104 on the geo-spatial map 200. In one example embodiment, the member data may include a name, community, and/or address associated with the member. The block 402 may also display information related to the privacy preference associated with the community 104. In one example embodiment, the privacy preference may represent whether the community 104 is a publicly available community or a private community. For example, the publicly available community is a community in which profiles of the members 106A-N are available for public view. Alternatively, the private community is a community in which profiles may be hidden from public view.

The make your profile public option 404 may enable the member 106 to make his/her profile to be publicly available for other members of the community 104. In one example embodiment, the other members 106A-N of the community 104 may access the member's profile to view, update and/or post comments in the member's profile. The welcome message 408 may display a name of the member 106 of the community 104 associated with a webpage. In other words, the welcome message 408 may be displayed to the member 106 upon logging into the webpage.

The message block 410 may display information regarding a confirmation of a residence of the member 106 in the community boundary 406. For example, the validity may be determined based on a confirmation of the residence of the member 106 in the community boundary 406. The click option 412 may enable the member 106 to view other profiles associated with the community 104 based on the validity of the member 106 (e.g., as illustrated in the message block 410).

In the example embodiment illustrated in FIG. 4A, the user interface view 400A displays the community boundary 406 created corresponding to the community boundary selection 208, and the block 402. The block 402 displays a name of the member 106 “John Smith” associated with the community 104 “Sunset Hill”. As described above, the Sunset Hill community may be created corresponding to the community boundary 406 associated with an address “Pleasantville, Calif., United States”. The profiles of the Sunset Hill community may be hidden based on the privacy preference selected by the members 106A-N and/or the representative of the Sunset Hill community. John (e.g., the user) may be allowed to make his profile public (e.g., accessible by other members of Sunset Hill) using the make your profile public option 404. The welcome message 408 displays “Welcome John” representing a webpage associated with a user “John”.

The message block 410 displays “You are a resident of Sunset Hill” indicating a confirmation of the residence of the member 106 at the region corresponding to Sunset Hill community. For example, the residence of the member at the region may be confirmed by the other members and/or the representative of Sunset Hill community. In one example embodiment, the community boundary 406 corresponding to the residence of John may be determined using the location information stored in the geo-spatial repository 112. In addition, John may view other profiles associated with Sunset Hill community using the click option 412. In one example embodiment, John may post comments and/or testimonials, create groups and/or delete bad comments in profiles through the click option 412.

FIG. 4B is a user interface view 400B of restricting access to another member 106 of the community network 102 to view the profiles associated with the community 104, according to one embodiment. Particularly, FIG. 4B illustrates the geo-spatial map 200, the community boundary 406, a block 414, a join community option 416, a welcome message 418, a message block 420 and a click option 422, according to one embodiment.

The block 414 may display a name of the community 104 and address associated with the community 104. The block 414 also displays the privacy preference selected by the members 106A-N of the community 104. The join community option 416 may allow another member 106 of the community network 102 to join the community 104 (e.g., Sunset Hill) based on a residence of the member 106 in the region corresponding to the community 104.

The welcome message 418 may display a name of the member 106 of the community network 102 associated with the webpage. The message block 420 may display information regarding a confirmation of a residence of the member 106 in the community boundary 406. The click option 422 may enable the member 106 of the community network 102 to join the community 104 based on the residence in the region corresponding to the community boundary 406.

In the example embodiment illustrated in FIG. 4B, the user interface view 400B displays the community boundary 406 corresponding to Sunset Hill community and address “Pleasantville, Calif., United States” associated with Sunset Hill community. The welcome message 418 displays “Welcome Bob” representing a webpage associated with a user “Bob”. The message block 420 displays “You are not a resident of Sunset Hill” indicating the residence of the member 106 is not in the region corresponding to the community boundary 406.

As illustrated in FIG. 4B, Bob is not a resident of the Sunset Hill community and thus may not be allowed to view profiles associated with the Sunset Hill community. However, Bob may be allowed to select a new residence in the region corresponding to the community boundary 406 associated with the Sunset Hill community using the click option 422. Further, Bob may join the Sunset Hill community (e.g., using the click option 422) corresponding to the new residence upon confirmation of his residence within the Sunset Hill community.

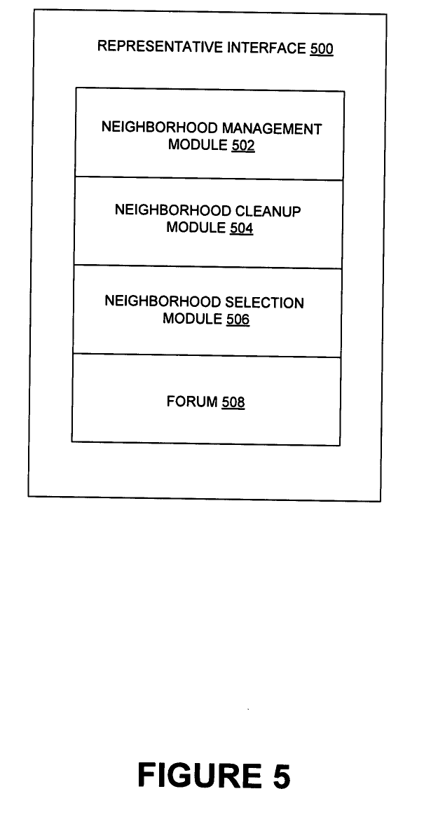

FIG. 5 is a block diagram representation of a representative interface 500 associated with a representative, according to one embodiment. Particularly, FIG. 5 illustrates a neighborhood management module 502, a neighborhood cleanup module 504, a neighborhood selection module 506 and forum 508, according to one embodiment.

The representative interface 500 may be an interface accessible by the representative. The representative may be an individual selected from the members 106A-N of the community network 102 based on an activity level of each member 106. In one example embodiment, the representative may act as a moderator to draw a community boundary selection 208 and to regulate entries obtained from the region corresponding to the community boundary selection 208. The neighborhood management module 502 may be configured to provide a neighborhood management option to the representative. For example, the neighborhood management option may include a process of controlling the entries associated with the community 104. In one example embodiment, the neighborhood management option may allow the representative to reject the entries outside the community boundary selection 208.

The neighborhood cleanup module 504 may be configured to provide a member profile regulation option to the representative. For example, the member profile regulation option may include editing of members'profile associated with the community 104, hiding the community 104 from a public view of the community network 102, and/or restricting access to the other members of the community network 102 based on the privacy preference.

The neighborhood selection module 506 may be configured to obtain the community boundary selection 208 from the representative. For example, the community boundary selection 208 may be a polygon drawn by the representative corresponding to a particular community 104. In one embodiment, the community boundary selection 208 may also be drawn as a rectangle, square or any other shape.

The forum 508 may be configured to display comments posted by the members 106A-N of the community 104. The members 106A-N of the community 104 may post comments regarding security aspects, bad profiles, modifications in profiles, community 104 events, and/or other opinions regarding the community 104. The comments may be displayed to the representative as well as other members 106A-N of the community 104.

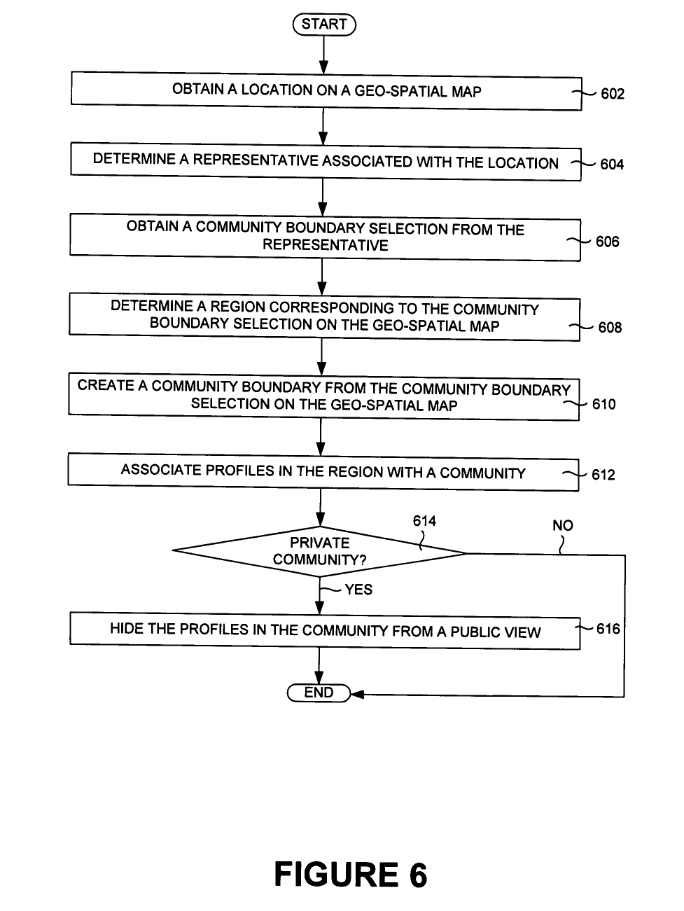

FIG. 6 is a flow chart to define a community boundary in a community network 102, according to one embodiment. In operation 602, a location is obtained (e.g., using the geo-spatial repository 112 of FIG. 1) on a geo-spatial map (e.g., the geo-spatial map 200 of FIG. 2). In operation 604, a representative associated with the location is determined. In one example embodiment, the representative may be determined based on an activity level of each of the members 106A-N of the community network 102. In one example embodiment, the activity level is determined (e.g., using the member management module 108 of FIG. 1) based on the list of activities that the members 106A-N perform on a day to day basis. The activities may include building the community network 102, uploading photos to the community network 102, commenting about the bad profiles in the community network 102, etc.

In operation 606, a community boundary selection 208 is obtained from the representative. For example, the community boundary selection 208 may be a polygon drawn (e.g., using the selection tools 206 of FIG. 2) corresponding to the community 104 on the geo-spatial map 200. In operation 608, a region corresponding to the community boundary selection 208 is obtained on the geo-spatial map 200. For example, the community boundary selection 208 may be drawn to outline a region on the geo-spatial map 200.

In operation 610, a community boundary 406 is created (e.g., using the boundary management module 110 of FIG. 1) from the community boundary selection 208 on the geo-spatial map 200. For example, the community boundary 406 may be created based on a vote obtained from one or more members 106A-N of the community 104. In operation 612, profiles in the region are associated with the community 104. For example, profiles may include the member data (e.g., name, location information, and/or profession, etc.) associated with the members 106A-N.

In operation 614, a determination is made whether to make the community 104 private or not. In one example embodiment, the privacy option may be selected (e.g., through the check box 312 of FIG. 3) by the members 106A-N of the community 104 through the voting module 308. If the members 106A-N are not willing to specify the privacy preference and/or have voted to not make the community 104 private, then the process may terminate. In operation 616, the profiles in the community 104 are hidden (e.g., using the boundary management module 110 of FIG. 1) from a public view of the community network 102 based on the privacy preference set by the members 106A-N of the community 104.

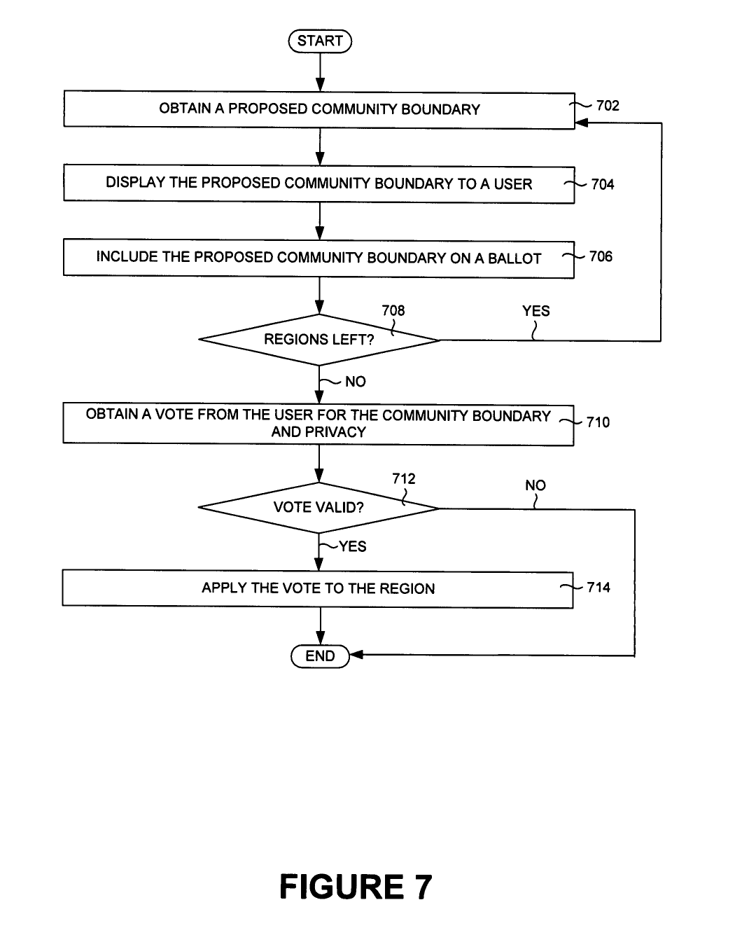

FIG. 7 is a flow chart to obtain a vote from a user corresponding to a community boundary (e.g., the community boundary 406 of FIG. 4) and a privacy preference, according to one embodiment. In operation 702, the proposed community boundary 406 is obtained. In one example embodiment, a number of proposed community boundaries created by a representative may be displayed to the user. Alternatively, proposed community boundaries may be submitted by users within the proposed community boundaries.

In operation 704, the proposed community boundary 406 is displayed (e.g., using the geo-spatial map 200 of FIG. 4A-B) to the user. In operation 706, the proposed community boundary 406 may be included on a ballot. In one example embodiment, the ballot may include a number of proposed community boundaries associated with a community. In operation 708, a determination is made whether any of the regions corresponding to proposed community boundaries are remaining. The process may repeat until all the proposed community boundaries corresponding to a user's request are obtained, displayed, and included on the ballot.

In operation 710, a vote from the user is obtained (e.g., using the voting module 308 of FIG. 3) for selecting the community boundary 406 and/or for earmarking privacy. For example, the member 106 may select the community boundary 406 based on a residence of the member 106 in the corresponding region associated with the community 104. Further, the user may also select privacy preference corresponding to the region to make the region private. In operation 712, a validity of the vote is determined. In one example embodiment, the validity may be determined based on the residence of the member 106 in the region associated with the community boundary 406. The validity may also be based on the member's 106 standing in the community 104. For example, the member 106 may be suspended from voting if the member 106 is inactive in the community 104 and/or fails to contribute to the community 104.

If the vote is not valid, then the process may terminate without associating the member 106 with the proposed community 104. If the vote is valid, then the vote is applied (e.g., through the geo-spatial map 200 of FIG. 3) to the region. In one example embodiment, the proposed community boundary 406 is determined (e.g., using the boundary management module 110 of FIG. 1) for the member 106 of the community network 102 based on the vote. Further, the privacy preferences selected by the user corresponding to the community 104 may be applied to the community 104 on the geo-spatial map 200.

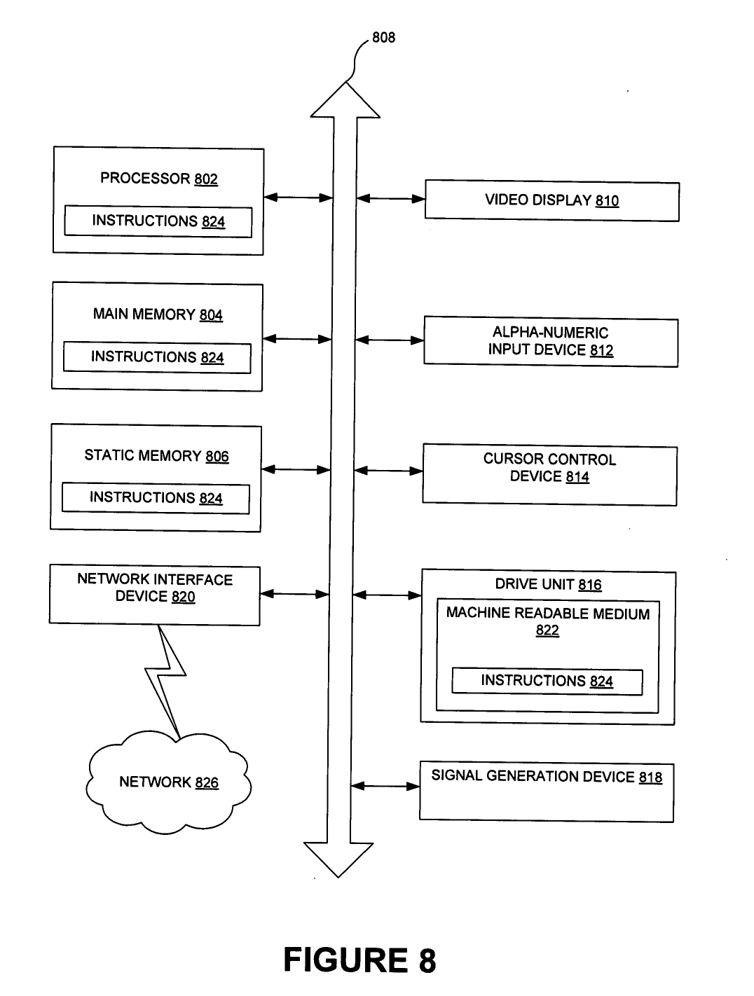

FIG. 8 is a diagrammatic system view 800 of a data processing system in which any of the embodiments disclosed herein may be performed, according to one embodiment. Particularly, the diagrammatic system view 800 of FIG. 8 illustrates a processor 802, a main memory 804, a static memory 806, a bus 808, a video display 810, an alpha-numeric input device 812, a cursor control device 814, a drive unit 816, a signal generation device 818, a network interface device 820, a machine readable medium 822, instructions 824, and a network 826, according to one embodiment.

The diagrammatic system view 800 may indicate a personal computer and/or a data processing system in which one or more operations disclosed herein are performed. The processor 802 may be microprocessor, a state machine, an application specific integrated circuit, a field programmable gate array, etc. (e.g., Intel® Pentium® processor). The main memory 804 may be a dynamic random access memory and/or a primary memory of a computer system.

The static memory 806 may be a hard drive, a flash drive, and/or other memory information associated with the data processing system. The bus 808 may be an interconnection between various circuits and/or structures of the data processing system. The video display 810 may provide graphical representation of information on the data processing system. The alpha-numeric input device 812 may be a keypad, keyboard and/or any other input device of text (e.g., special device to aid the physically handicapped). The cursor control device 814 may be a pointing device such as a mouse.

The drive unit 816 may be the hard drive, a storage system, and/or other longer term storage subsystem. The signal generation device 818 may be a bios and/or a functional operating system of the data processing system. The network interface device 820 may be a device that may perform interface functions such as code conversion, protocol conversion and/or buffering required for communication to and from a network. The machine readable medium 822 may provide instructions on which any of the methods disclosed herein may be performed. The instructions 824 may provide source code and/or data code to the processor 802 to enable any one or more operations disclosed herein.

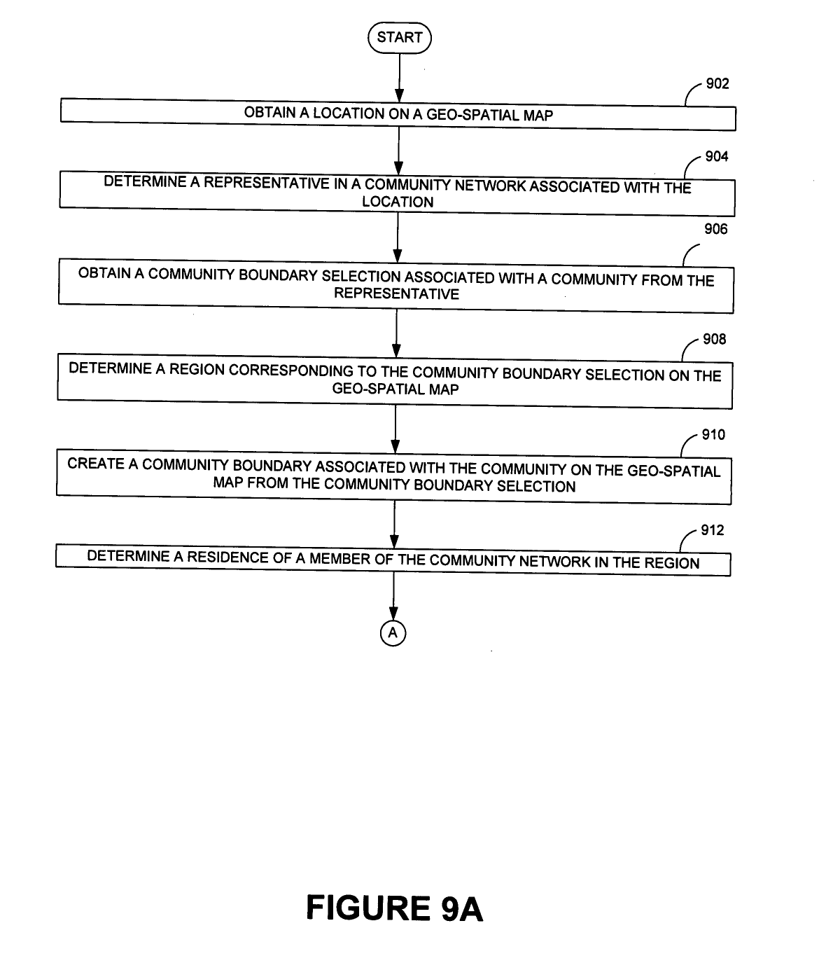

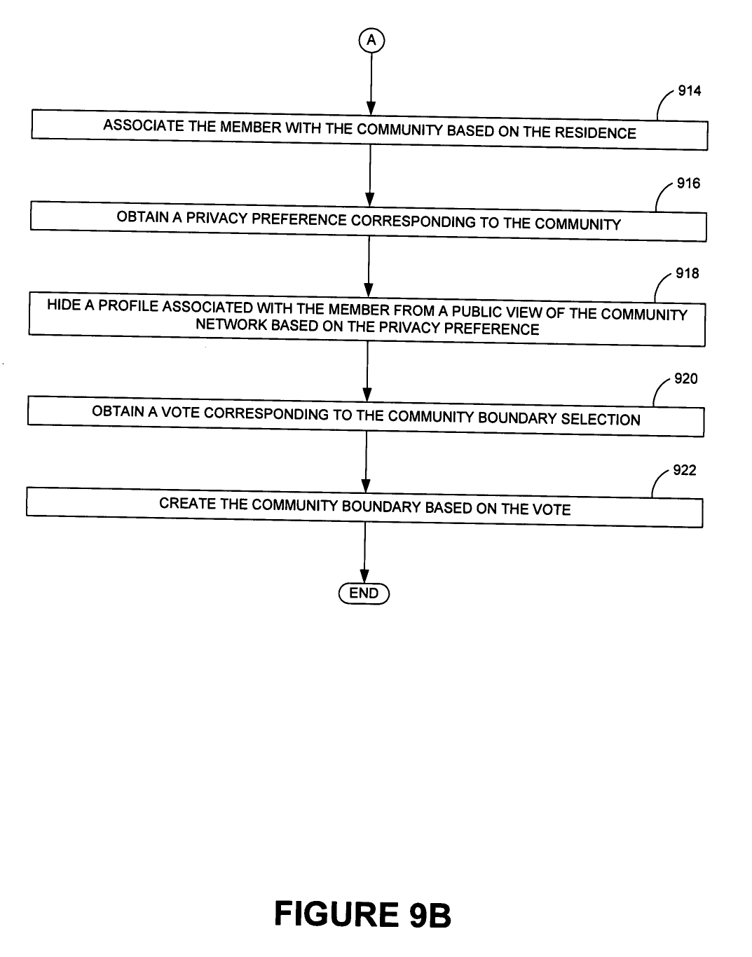

FIG. 9A is a process flow of creating a community boundary (e.g., the community boundary 406 of FIG. 4) associated with a community (e.g., the community 104 of FIG. 1) on a geo-spatial map (e.g., the geo-spatial map 200 of FIGS. 2, 3, and 4A-B), according to one embodiment. In operation 902, a location (e.g., may include a latitude, longitude and altitude coordinate) may be obtained (e.g., using the geo-spatial repository 112 of FIG. 1) on the geo-spatial map 200. In operation 904, a representative (e.g., may be an elected official) in the community network 102 associated with the location may be determined (e.g., using the member management module 108 and the member repository 114 of FIG. 1). In operation 906, a community boundary selection (e.g., the community boundary selection 208 of FIG. 2) associated with the community 104 may be obtained (e.g., using the boundary management module 110 of FIG. 1) from the representative.

In operation 908, a region (e.g., the regions 1 302, 2 304 and 3 306 of FIG. 3) corresponding to the community boundary selection 208 (e.g., may include a polygon) may be determined on the geo-spatial map 200. In operation 910, the community boundary 406 associated with the community 104 may be created (e.g., using the boundary management module 110 of FIG. 1) on the geo-spatial map 200 from the community boundary selection 208. In operation 912, a residence of a member (e.g., of the members 106A-N of FIG. 1) of the community network 102 may be determined (e.g., using the geo-spatial repository 112 of FIG. 1) in the region.

FIG. 9B is a continuation of the process flow of FIG. 9A, showing additional processes, according to one embodiment. In operation 914, the member 106 may be associated with the community 104 based on the residence. In operation 916, a privacy preference corresponding to the community 104 may be obtained (e.g., using the voting module 308 of FIG. 3). In operation 918, a profile associated with the member 106 may be hidden from a public view of the community network 102 based on the privacy preference. In operation 920, a vote corresponding to the community boundary selection may be obtained (e.g., using the voting module 308 of FIG. 3). In operation 922, the community boundary 406 may be created (e.g., using the boundary management module 110 of FIG. 1) based on the vote.

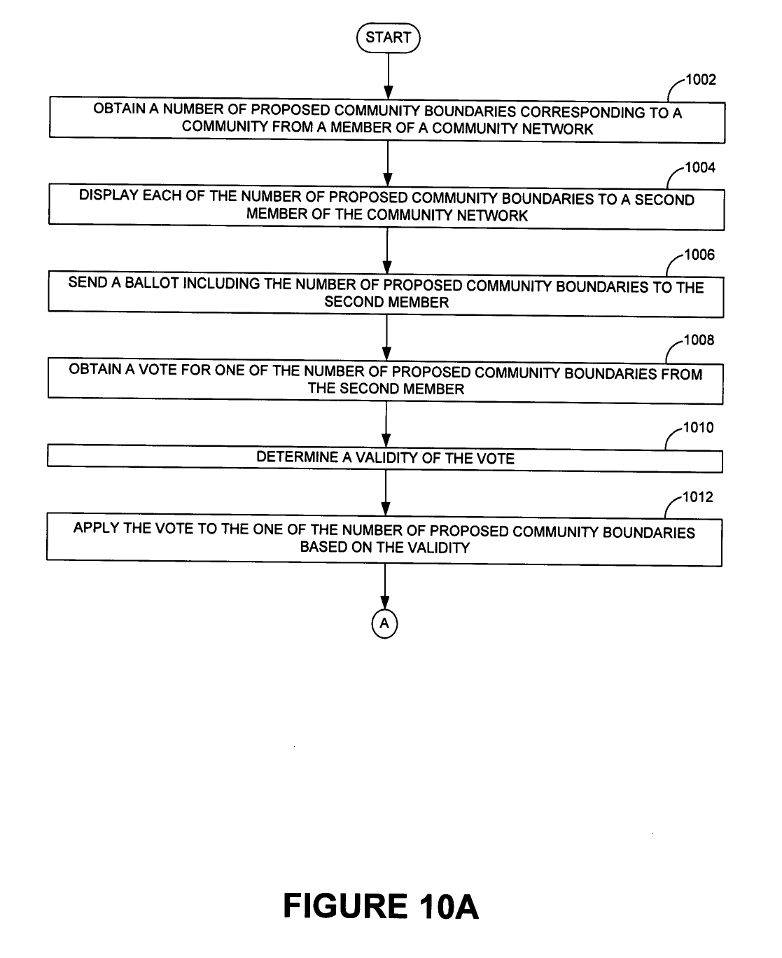

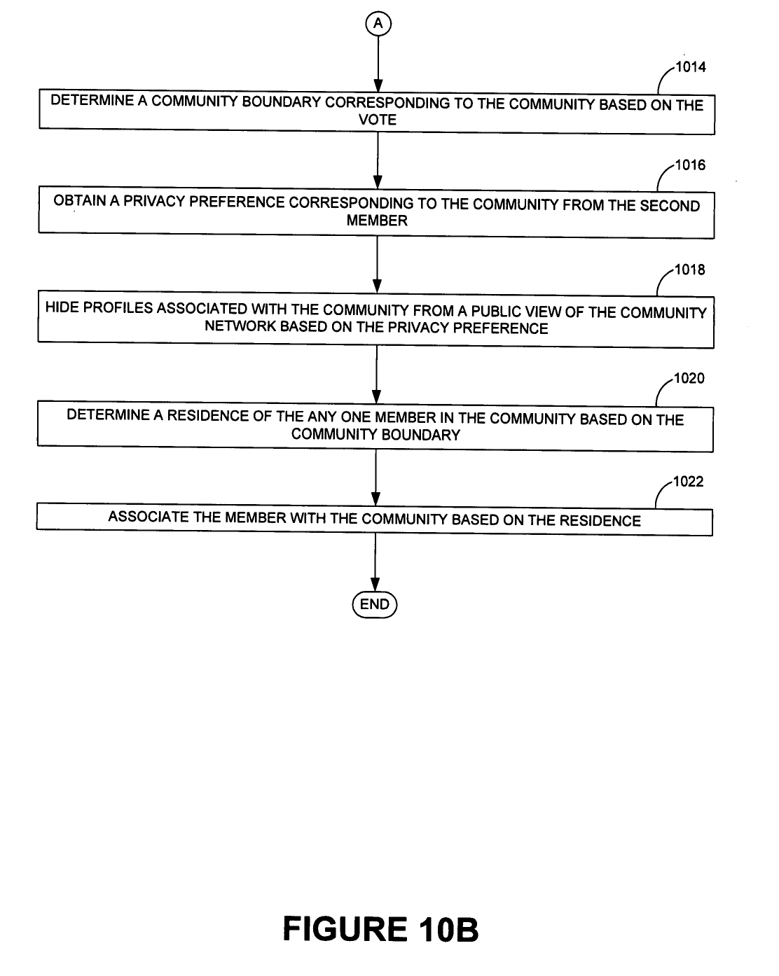

FIG. 10A is a process flow of determining a community boundary (e.g., the community boundary 406 of FIG. 4) corresponding to a community (e.g., the community 104 of FIG. 1) based on a vote, according to one embodiment. In operation 1002, a number of proposed community boundaries (e.g., the regions 1 302, 2 304 and 3 306 of FIG. 3) corresponding to the community 104 may be obtained from a member (e.g., of the members 106A-N of FIG. 1) of a community network (e.g., the community network 102 of FIG. 1). In operation 1004, each of the number of proposed community boundaries 1 302, 2 304 and 3 306 may be displayed (e.g., through the geo-spatial map 200 of FIG. 3) to a second member (e.g., of the members 106A-N of FIG. 1) of the community network 102. In operation 1006, a ballot including the number of proposed community boundaries 1 302, 2 304 and 3 306 may be sent to the second member 106. In operation 1008, a vote corresponding to one of the number of proposed community boundaries 1 302, 2 304 and 3 306 may be obtained (e.g., using the voting module 308 of FIG. 3) from the second member 106. In operation 1010, a validity of the vote may be determined (e.g., based on a residence of the second member 106). In operation 1012, the vote may be applied to the one of the proposed community boundaries 1 302, 2 304 and 3 306 based on the validity.

FIG. 10B is a continuation of the process flow of FIG. 10A, showing additional processes, according to one embodiment. In operation 1014, the community boundary 406 corresponding to the community 104 may be determined (e.g., using the boundary management module 110 of FIG. 1) based on the vote. In operation 1016, a privacy preference corresponding to the community 104 may be obtained (e.g., using the voting module 308 of FIG. 3) from the second member 106. In operation 1018, profiles associated with the community 104 may be hidden from a public view of the community network 102 (e.g., based on the privacy preference). In operation 1020, a residence of the member 106 in the community 104 may be determined (e.g., using the geo-spatial repository 112 of FIG. 1) based on the community boundary 406. In operation 1022, the member 106 may be associated with the community 104 based on the residence.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., Application Specific Integrated Circuitry (ASIC) and/or in Digital Signal Processor (DSP) circuitry). For example, the member management module 108, the boundary management module 110, the voting module 308, the neighborhood management module 502, the neighborhood cleanup module 504, the neighborhood selection module 506 and other modules of FIGS. 1-10B may be enabled using a member management circuit, a boundary management circuit, a voting circuit, a neighborhood management circuit, a neighborhood cleanup circuit, a neighborhood selection circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of organizing a community network, comprising:
obtaining a location on a geo-spatial map;
determining a representative in the community network associated with the location;
obtaining a community boundary selection associated with a community from the representative;
determining a region corresponding to the community boundary selection on the geo-spatial map; and
creating a community boundary associated with the community on the geo-spatial map from the community boundary selection.

2. The method of claim 1, further comprising:
determining a residence of a member of the community network in the region; and
associating the member with the community based on the residence.

3. The method of claim 2, further comprising:
obtaining a privacy preference corresponding to the community; and
hiding a profile associated with the member from a public view of the community network based on the privacy preference.

4. The method of claim 1, further comprising:
obtaining a vote corresponding to the community boundary selection; and creating the community boundary based on the vote.

5. The method of claim 1, wherein the community boundary selection comprises a polygon.

6. The method of claim 1, wherein the representative comprises an elected official.

7. The method of claim 1, wherein the location comprises a latitude, a longitude and an altitude.

8. A community network, comprising:
a member repository comprising a plurality of members;
a geo-spatial repository comprising a plurality of locations on a geo-spatial map;
a member management module configured to obtain member data associated with each of the plurality of members, wherein the member data comprises one of the plurality of locations; and
a boundary management module configured to:
determine a representative from the plurality of members associated with the one of the plurality of locations;
obtain a community boundary selection associated with a community from the representative;
determine a region corresponding to the community boundary selection on the geo-spatial map; and
create a community boundary for the community on the geo-spatial map from the community boundary selection.

9. The community network of claim 8, wherein the member management module is further configured to:
determine an activity level of each of the plurality of members in the member repository, wherein the representative is determined based on the activity level.

10. The community network of claim 8, further comprising:
a representative interface accessible by the representative, comprising:
a neighborhood management module configured to provide a neighborhood management option to the representative;
a neighborhood cleanup module configured to provide a member profile regulation option to the representative;
a neighborhood selection module configured to obtain the community boundary selection from the representative; and
a forum configured to display a comment from at least one of the plurality of members.

11. The community network of claim 8, wherein the boundary management module is further configured to:
determine a residence of one of the plurality of members in the region; and associate the one of the plurality of members with the community based on the residence.

12. The community network of claim 11, wherein the boundary management module is further configured to:
obtain a privacy preference corresponding to the community; and hide a profile associated with the one of the plurality of members from a public view of the community network based on the privacy preference.

13. The community network of claim 8, wherein the boundary management module is further configured to:
obtain a vote corresponding to the community boundary selection; and create the community boundary based on the vote.

14. The community network of claim 8, wherein the community boundary selection comprises a polygon.

15. The community network of claim 8, wherein the representative comprises an elected official.

16. The community network of claim 8, wherein each of the plurality of locations comprises a latitude, a longitude and an altitude.

17. A method of organizing a community network, comprising:
obtaining a plurality of proposed community boundaries corresponding to a community from at least one member of the community network;
displaying each of the plurality of proposed community boundaries to a second member of the community network;
sending a ballot comprising the plurality of proposed community boundaries to the second member;
obtaining a vote corresponding to one of the plurality of proposed community boundaries from the second member;
determining a validity of the vote;
applying the vote to the one of the plurality of proposed community boundaries based on the validity; and
determining a community boundary corresponding to the community based on the vote.

18. The method of claim 17, further comprising:
obtaining a privacy preference corresponding to the community from the second member; and
hiding a plurality of profiles associated with the community from a public view of the community network based on the privacy preference.

19. The method of claim 17, further comprising:
determining a residence of the at least one member in the community based on the community boundary; and
associating the at least one member with the community based on the residence.

20. The method of claim 17, wherein the validity is determined based on a residence of the second member.
